(19) United States
(12) Patent Application Publication
(10) Pub. No.: US 2006/0018545 A1
(43) Pub. Date: Jan. 26, 2006

(54) User interface and database structure for Chinese phrasal stroke and phonetic text input

(76) Inventors: Lu Zhang, Bothell, WA (US); Pim Van Meurs, Kenmore, WA (US); Lian He, Issaquah, WA (US); Ethan Bradford, Seattle, WA (US); Jianchao Wu, Sammamish, WA (US); Jenny Huang-Yu Lai, Seattle, WA (US); Kengchong Wong, Bellevue, WA (US); Siu Ming Louis Leung, Redmond, WA (US)

Correspondence Address: GLENN PATENT GROUP, 3475 EDISON WAY, SUITE L, MENLO PARK, CA, 94025, US

(21) Appl. No.: 11/040,911

(22) Filed: Jan. 21, 2005

Related U.S. Application Data
(60) Provisional application No. 60/591,465, filed on Jul. 26, 2004.
(60) Provisional application No. 60/590,713, filed on Jul. 23, 2004.

(51) Int. Cl. G06K 9/18

(52) U.S. Cl. 382/185

(57) ABSTRACT

The invention provides a stroke and phonetic text input entry system that has substantially the same definition of stroke match as that used in T9, where the input is a phrasal input rather than a character input. The invention solves the problem of Chinese phrasal stroke and phonetic text input by allowing users to enter an arbitrary number of strokes for each character in a phrase, where each character is separated by a delimiter. In this way, the invention provides a system that is easily learned and efficiently applied. Thus, the invention makes it possible for users to enter multiple characters while keeping their single character input habits. Each Chinese character has a standard stroke sequence in Guo Biao (GB), which is the standard for mainland China, or multiple sequences for BIG5 Chinese Character Encoding for Traditional (Complex) Characters, which is the de facto standard in Taiwan but not used in mainland China. With the invention, users do not have to enter the complete sequence for a single character, but instead can stop at any point and enter a delimiter which indicates the end of the previous character and the start of the next character. The whole stroke sequence entered by the user can then be split into a few groups that are separated by zero or more delimiters. Phrases can then be identified by user entry of groups of characters. The presently preferred phrase matching criteria are as follows: the first stroke group matches the leading stroke sequence of the first character of the phrase; the second stroke group matches the leading stroke sequence of the second character of the phrase, etc; the phrases that match the entered stroke sequence are presented to the user for selection. A user interface design for Chinese phrasal stroke text input is also provided.

### CROSS REFERENCE TO RELATED APPLICATIONS

This application claims priority to U.S. provisional patent application Ser. No. 60/591,465 filed Jul. 26, 2004 and U.S. provisional patent application Ser. No. 60/590,713 filed Jul. 23, 2004, the contents of both of which are incorporated by reference here in their entirety by this reference.

### BACKGROUND OF THE INVENTION

1. Techical Field

The invention relates to data entry. More particularly, the invention relates to a user interface and database structure for Chinese phrasal stroke and phonetic text input.

2. Description of the Prior Art

Chinese stroke text input solutions for the handheld devices currently available on the market are predominantly character based. In such solutions, the user stroke sequence for entry of a character is typically delimited by the user entry of a terminator.

Single character input systems are known. See, for example, the T9 product (T9) offered by AOLITegic Communication Inc. (see http://www.tegic.com/).

A phrasal stroke input system is offered by Beijing d-Ear Technologies Co. (see http://www.d-ear.com/Frameset.htm). While the d-Ear product provides phrasal input, it greatly changes the manner in which users' would otherwise enter single characters. Thus, the user is forced to enter exactly four strokes if the character has more than four strokes. This approach presents at least the following problems:
It does not allow shortcuts, for example the entry of one stroke for each character in the phrase if the phrase is frequently used; and
The user may want to enter more strokes for certain characters and fewer strokes for other characters, but the d-Ear input system does not support this feature.

It would be advantageous to provide a user interface and database structure for Chinese phrasal stroke and phonetic text input that overcomes the limitations of known devices.

### SUMMARY OF THE INVENTION

The invention provides a stroke and phonetic text input entry system that has substantially the same definition of stroke match as that used in T9, where the input is a phrasal input rather than a character input. Phrasal stroke input can make the user's text input faster and more accurate compared to character stroke input. The invention solves the problem of Chinese phrasal stroke by allowing users to enter an arbitrary number of strokes for each character in a phrase, where each character is separated by a delimiter. This invention also allows stroke and phonetic phrasal input methods to share the same phrasal data. In this way, the invention provides a system that is easily learned and efficiently applied. Thus, the invention makes it possible for users to enter multiple characters while keeping their single character input habits.

Each Chinese character has a standard stroke sequence in Guo Biao (GB), which is the standard for mainland China (although some users may use non-standard stroke sequences), or multiple sequences for BIG5 Chinese Character Encoding for Traditional (Complex) Characters, which is the de facto standard in Taiwan but not used in mainland China. With the invention, users do not have to enter the complete sequence for a single character, but instead can stop at any point and enter a delimiter which indicates the end of the previous character and the start of the next character. The whole stroke sequence entered by the user can then be split into groups that are separated by zero or more delimiters. Phrases can then be identified by user entry of groups of characters. The presently preferred phrase matching criteria are as follows:
The first stroke group matches the leading stroke sequence of the first character of the phrase;
The second stroke group matches the leading stroke sequence of the second character of the phrase, etc;
The phrases that match the entered stroke sequence are presented to the user for selection.

A user interface design for Chinese phrasal stroke is also provided.

### BRIEF DESCRIPTION OF THE DRAWINGS

FIG. 1 depicts a device for entering a Chinese phrase, showing a text area, a stroke area, and a selection area according to the invention; and

FIG. 2 is a block schematic diagram showing a system for phrasal stroke and phonetic text input according to the invention.

### DETAILED DESCRIPTION OF THE INVENTION

Definitions, Acronyms, and Abbreviations

The terms listed on Table 1 below have the meaning in this document that is ascribed to them therein.

TABLE 1
Definitions, Acronyms, and Abbreviations

| Term | Description |
|---|---|
| PTI | Phrasal text input, i.e. a way to input a |
| | Chinese word/phrase instead of character by |
| | character. |
| LDB | Linguistic database, i.e. where the character, |
| | word, and phrase information is stored. |
| SID | Stroke ID, i.e. the index of Chinese characters |
| | sorted by stroke. |
| PID | Phonetic ID, i.e. the index of Chinese |
| | characters sorted by phonetic spelling. |
| Wild card | A key that the user enters to match any stroke |
| | input. |
| Stroke | The most basic building blocks of Chinese |
| | characters. 5-stroke and 8 stroke systems |
| | are most popular. |
| Component | Defined as a part of a Chinese character in |
| | the leading stroke position. |
| Fuzzy (“Mohu”) | A pair or multiple pairs of phonetic initials |
| phonetic spelling | (Shengmu in pinyin) or finals (Yunmu in |
| | pinyin) that are not distinguishable to certain |
| | groups of users |
| Phrase | One or more words |

The invention provides a stroke text input entry system that has substantially the same definition of stroke match as that used in T9, where the input is a phrasal input rather than a character input. The invention solves the problem of Chinese phrasal stroke text input by allowing users to enter an arbitrary number of strokes wild cards or a component for each character in a phrase, where each character is separated by a delimiter. In this way, the invention provides a system that is easily learned and efficiently applied. Thus, the invention makes it possible for users to enter multiple characters while keeping their single character input habits.

Each Chinese character has a standard stroke sequence in Guo Biao (GB), which is the standard for mainland China, or multiple sequences for BIG5 Chinese Character Encoding for Traditional (Complex) Characters, which is the de facto standard in Taiwan but not used in mainland China. With the invention, users do not have to enter the complete sequence for a single character, but instead can stop at any point and enter a delimiter which indicates the end of the previous character and the start of the next character. The whole stroke sequence entered by the user can then be split into a few groups that are separated by zero or more delimiters. Phrases can then be identified by user entry of groups of characters.

The presently preferred phrase matching criteria are as follows:
The first stroke group matches the leading stroke sequence of the first character of the phrase;
The second stroke group matches the leading stroke sequence of the second character of the phrase, etc;
The phrases that match the entered stroke sequence are presented to the user for selection.

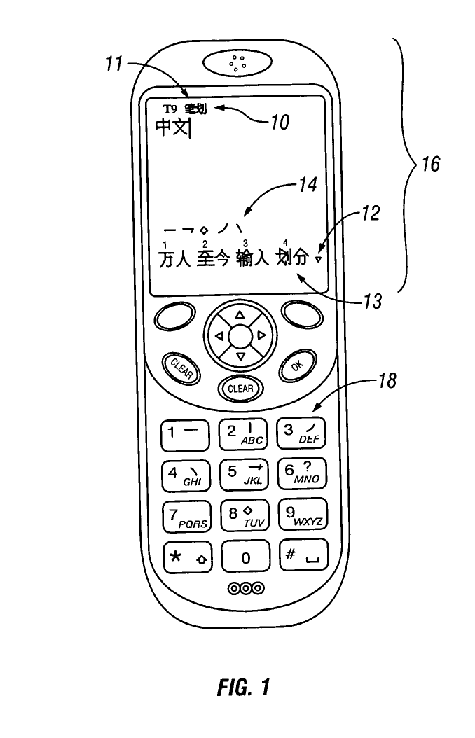

A user interface design for Chinese phrasal stroke and phonetic text input is shown in FIG. 1, which depicts a device for entering a Chinese phrase, showing a text area 10, a stroke area 14, and a selection area 12 according to the invention. The device comprises a data entry keypad 18 in which the 1-5 keys bear an indication of the stroke that is input when the key is pressed. Key 8 bears a delimiter symbol; key 8 is pressed to indicate the end of a character and the start of a next character during phrasal input and selection. In FIG. 1, a word 11 has been entered into the text area. The stroke area 14 shows the stroke sequence entered by the user, where the diamond symbol indicates that the user has entered a delimiter. There are four words in the selection area (1-4). The next word 13 is the third selection (3) in the selection area. In a T9 embodiment of the invention, the user press-holds a key (1-4 in the example shown in FIG. 1) to select a corresponding phrase. The delimiters divide the user input into a few stroke sequences. All the words in the selection area (1-4) should have characters that match the stroke sequences, respectively. In this example, the user entered key 1, key 5, key 8 as a delimiter, key 3, and key 4. All the phrases in the selection area (1-4) have the first characters that have stroke sequences starting with “15” and second characters with stroke sequence of “34 . . . ”. Those skilled in the art will appreciate that the device shown in FIG. 1 is provided for purposes of illustration and example only, and that many different input devices may be employed to implement the invention herein disclosed.

Data Structure

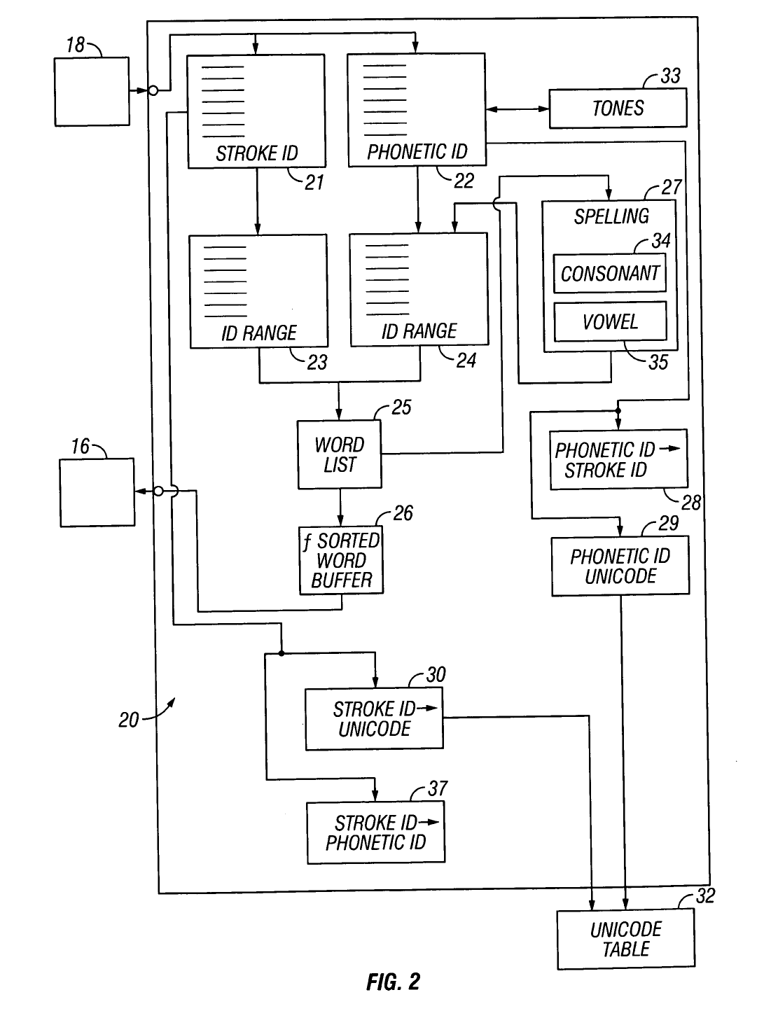

FIG. 2 is a block schematic diagram showing an apparatus for phrasal stroke and phonetic text input according to the invention. The data structure 20 of the invention comprises two kinds of internal IDs for the Chinese character set: stroke ID 21 and phonetic ID 22.
Stroke ID is defined as the index of stroke sorted Chinese characters.
Phonetic ID is defined as the index of phonetic-sorted Chinese characters or the index of key-sorted, then phonetically sorted Chinese characters. The phonetic sort may be further sorted by the tone of the character to support tone options in phrases.

The data structure also includes a word list structure 25 and two ID range lookup structures for the Chinese character set: one for stroke 23 and one for phonetic 24. The data structure also includes lookup tables which can translate between phonetic ID and stroke ID 28, and from either phonetic ID or stroke ID to Chinese characters 29, for example encoded in Unicode.

A Chinese input system can have either a phonetic or a stroke ID range lookup structure or both for single character input. With the provision of a word list, the input system supports phrasal text input. If a system supports only stroke or phonetic input, the lookup tables translating between PID and SID are not necessary.

The core finds the stroke or phonetic ID range for the given stroke or phonetic input based on the ID range structure. The word list is scanned to find out the words whose character IDs fall into the ranges. The words are then sent to a word buffer 26 sorted by frequency or other criteria, for example by whether a key input matches the word exactly or partially.

Lookup Tables

The lookup tables must support one-to-many mapping due to the fact that one Chinese character may have different phonetic pronunciations and multiple stroke sequences. The database may contain the frequency information about the different pronunciations and different stroke sequences. The lookup tables in the presently preferred embodiment of the invention comprise: stroke ID to phonetic ID 31, phonetic ID to stroke ID 28, and phonetic ID (or stroke ID) to Unicode 29, 30.

Stroke ID to phonetic ID and phonetic ID to stroke ID tables have the same format. There are two tables: the main table and the multiple value table.

The main table is:
0xxx xxxx xxxx xxxx: if there are no multiple lookup values. X is the lookup value.
1nnn xxx xxx xxxx: if there are multiple values. X points to the address in the multiple value table and n+2 is the number of multiple values. The multiple values, n+2 words, can be read from the address. Each multiple value table has an adjustment table in case the number of total multiple values exceeds 4 k.

The unicode table 32 can be accessed either from the phonetic ID or stroke ID tables.

Phonetic Structure

From the users' point of view, the phonetic system is designed to convert the key sequence to spellings first, then to Chinese characters. Internally, the second step contains two parts: first to convert from spellings to phonetic IDs, then to Chinese characters.

Interpretation from Keys to Spellings

A phonetic tree is built for all the possible phonetic spellings for the words using T9 alpha techniques, which are covered by U.S. Pat. No. 5,818,437, U.S. Pat. No. 5,953,541, U.S. Pat. No. 6,011,554, U.S. Pat. No. 6,307,548, U.S. Pat. No. 6,286,064, U.S. Pat. No. 6,307,549, U.S. Pat. No. 5,945,928, U.S. Pat. No. 5,187,480, U.S. Pat. No. 6,646,573 and U.S. Pat. No. 6,636,162 and other U.S. and foreign pending patents. The input key sequence is fed into the T9 alpha core to generate the valid spellings. The spellings are presented to the user as spelling choices.

Interpretation from Spellings to Phonetic IDs

A list of all possible syllables is stored, sorted alphabetically. A spelling is compared with all the possible spellings and, if matched, the index of the spelling is used to look up the phonetic ID range. The phonetic ID range table is a list of starting phonetic IDs for each spelling.

The spellings of the syllables are saved for lookup purpose. Each syllable can have up to six letters. For a given syllable, the invention first searches the syllable table to try to match the spellings. If a match is found, the invention then uses the index to find the starting PID in the PID range table. The next entry in the PID range table is the ending PID. All the PIDs in the range have the same spelling.

In the phrasal input case, the spelling can be divided into a few syllables. Each syllable can have a corresponding PID range. The word data are searched to match the PIDs in a phrase to the PID ranges and find the matching phrases.

Tones

If the phonetic ID does not contain tone information or the PID is not sorted by tone, the tone information table 33 is needed to support tone input.

Each PID should have its own tone information in the format of:
pppx xxxx
   where p indicates the primary tone for the character of the spelling and X is a bit mask indicating the available tones for the character of the spelling.
   Mohu Phonetic Spelling Consideration

Mohu phonetic spelling concerns a phenomenon in which some phonetic users cannot distinguish a pair or multiple pair of phonetic initials or finals. For example, “hu” and “w”, “z” and “zh” or “an” and “ang.” These users cannot tell the difference among “zan,” “zhan,” “zang,” and “zhang.”

Mohu phonetic spelling is implemented based on the syllable tree. The core, also referred to herein as the engine, (see FIG. 2) scans the input key sequence. For each possible key combination that has an active mohu pair, the core applies the mohu pair and checks against the phonetic tree whether the new key sequence is valid. If it is, the instructions are further checked to make sure that the mohu pair shows up. If the mohu pair shows up, a spelling match is found. The process can be repeated recursively to get all the possible mohu phonetic spelling.

The Word Data

The word information, independent of input method, is stored separately. It should contain the information of a frequently used word set encoded in phonetic ID. The data structure is sorted by the phonetic IDs of the leading characters.

Stroke Design

The database includes a single character stroke tree. Each node in the tree is a key and the path to the node can form a key sequence. If the key sequence matches the stroke sequence of a character, the character is an exact match to the key sequence or the node. The numbers of exact matches and partial matches are saved in the node. Stroke ID is defined as the index in the character set sorted by stroke. Some Chinese characters, especially in traditional Chinese, can be written with more than one stroke sequences. The stroke sequences that are not most frequently used or not standard are called alternative stroke sequences of the character. A character with an alternative stroke sequence is treated as a different SID entry.

From this structure, the user entered key sequence in the tree can be followed to find a corresponding node. It is then possible to calculate the exact match stroke ID range and the partial match stroke ID range.

In single character input, the stroke ID ranges can be converted to a list of Chinese characters with the help of an SID to PID lookup table and a PID to Unicode lookup table, or a SID to Unicode lookup table.

In a phrasal input system, if the user enters a key sequence that can be split into mutiple sub-sequences, the stroke ID ranges can be found for each sub-sequence. The stroke ID ranges can be used as match criteria to search the matching phrases in the word data structure.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An input apparatus for phrasal stroke entry, comprising:
a user stroke entry device;
a module for receiving user stroke entry information from said stroke entry device, said module allowing users to enter an arbitrary number of strokes for each character in a phrase, where two adjacent characters are separated by a user entered delimiter;
a module for receiving user stroke entry information from said stroke entry device, said module splitting a whole stroke sequence entered by a user into a plurality of groups of stroke sequences that are separated by zero or more of said delimiters; and
a module for receiving user stroke entry information from said stroke entry device, said module identifying phrases by user entry of groups of characters.

2. The apparatus of claim 1, wherein users do not have to enter a complete sequence for a single character, but instead can stop at any point and enter a delimiter which indicates the end of a previous character and the start of a next character.

3. The apparatus of claim 1, wherein said text entry comprises Chinese phrasal stroke text input.

4. The apparatus of claim 1, further comprising:
a phrase matching module for applying phrase matching criteria to input strokes to identify phrasal input.

5. The apparatus of claim 4, said phrase matching criteria comprising:
determining if a first stroke group matches a leading stroke sequence of a first character of a phrase; and
determining if a second and subsequent stroke groups match a leading stroke sequence of respective second and subsequent characters of said phrase;
wherein phrases that match said entered stroke sequence are presented to said user for selection.

6. A user interface for a Chinese phrasal stroke [Ivy: there is no phonetic related description here. Also what is the difference between this claim and the 20^{th} claim?]text input apparatus, comprising:
a data entry keypad for receiving user stroke entries, said keypad comprising at least a plurality of stroke entry keys and at least one delimiter entry key, said delimiter key indicating the end of a character and the start of a next character during phrasal input and selection;
a display for representing a Chinese phrase to said user, said display comprising a text area, a stroke area, and a selection area; and
a data structure for:
receiving user stroke entry information from said keypad, said module allowing users to enter an arbitrary number of strokes for each character in a phrase, where each character is separated by a user entered delimiter;
receiving user stroke entry information from said keypad and splitting a whole stroke sequence entered by a user into a plurality of groups that are separated by zero or more of said delimiters; and
receiving user stroke entry information from said keypad and identifying phrases by user entry of groups of characters.

7. An apparatus for Chinese phrasal stroke and phonetic text input, comprising:
at least two internal IDs for a Chinese character set, said internal IDs comprising a stroke ID and a phonetic ID, wherein a stroke ID comprises an index of stroke sorted Chinese characters, and wherein a phonetic ID comprises either of an index of phonetic-sorted Chinese characters and an index of key-sorted, then phonetically sorted Chinese characters;
a word list for supporting phrasal text input; and
at least two ID range lookup structures for said Chinese character set, wherein an ID range lookup is provided for stroke inputs and an ID range lookup is provided for phonetic inputs.

8. The apparatus of claim 7, further comprising any of:
a lookup table for translating between phonetic ID and stroke ID;
a lookup table for translating between stroke ID and phonetic ID; and
any of a lookup table for translating from phonetic ID to Chinese characters in said Chinese character set and a lookup table for translating from stroke ID to Chinese characters in said Chinese character set.

9. The apparatus of claim 7, further comprising:
a tone information table, wherein said phonetic sort is further sorted by tone of a character to support tone options in phrases.

10. The apparatus of claim 7, further comprising:
a frequency sorted word buffer for receiving candidate words and/or phrases from said word list.

11. The apparatus of claim 7, wherein said lookup tables support one-to-many mappings.

12. The apparatus of claim 7, further comprising:
a phonetic database comprising key sequence information, spellings, and said phonetic ID.

13. The apparatus of claim 7, said word list further comprising:
a list of all possible spellings, sorted alphabetically;
wherein a spelling is compared with all possible spellings and, if matched, an index of said spelling is used to lookup a phonetic ID range;
wherein said phonetic ID range table comprises a list of ending phonetic IDs for each spelling.

14. The apparatus of claim 13, further comprising:
a spelling table, wherein said spellings within said table are organized by phonetic initials and finals.

15. An input method for phrasal stroke entry, comprising the steps of:
providing a user stroke entry device;
receiving user stroke entry information from said stroke entry device, said module allowing users to enter an arbitrary number of strokes for each character in a phrase, where each character is separated by a user entered delimiter;
receiving user stroke entry information from said stroke entry device, said module splitting a whole stroke sequence entered by a user into a plurality of groups of stroke sequence that are separated by zero or more of said delimiters; and
receiving user stroke entry information from said stroke entry device, said module identifying phrases by user entry of groups of characters.

16. The method of claim 15, wherein users do not have to enter a complete sequence for a single character, but instead can stop at any point and enter a delimiter which indicates the end of a previous character and the start of a next character.

17. The method of claim 15, wherein said text entry comprises Chinese phrasal stroke text input.

18. The method of claim 15, further comprising the step of:
applying phrase matching criteria to input strokes to identify phrasal input.

19. The method of claim 18, said step of applying phrase matching criteria comprising the steps of:
determining if a first stroke group matches a leading stroke sequence of a first character of a phrase; and
determining if a second and subsequent stroke groups match a leading stroke sequence of respective second and subsequent characters of said phrase;
wherein phrases that match said entered stroke sequence are presented to said user for selection.

20. A user interface method for a Chinese phrasal stroke and phonetic text input apparatus, comprising the steps of:
providing a data entry keypad for receiving user stroke entries, said keypad comprising at least a plurality of stroke entry keys and at least one delimiter entry key, said delimiter key indicating the end of a character and the start of a next character during phrasal input and selection;
providing a display for representing a Chinese phrase to said user, said display comprising a text area, a stroke area, and a selection area;
receiving user stroke entry information from said keypad, said module allowing users to enter an arbitrary number of strokes for each character in a phrase, where each character is separated by a user entered delimiter;
receiving user stroke entry information from said keypad and splitting a whole stroke sequence entered by a user into a plurality of groups that are separated by zero or more of said delimiters; and
receiving user stroke entry information from said keypad and identifying phrases by user entry of groups of characters.

21. A method for Chinese phrasal stroke and phonetic text input, comprising the steps of:
providing at least two internal IDs for a Chinese character set, said internal IDs comprising a stroke ID and a phonetic ID, wherein a stroke ID comprises an index of stroke sorted Chinese characters, and wherein a phonetic ID comprises either of an index of phonetic-sorted Chinese characters and an index of key-sorted, then phonetically sorted Chinese characters;
providing a word list for supporting phrasal text input; and providing at least two ID range lookup structures for said Chinese character set, wherein an ID range lookup is provided for stroke inputs and an ID range lookup is provided for phonetic inputs.

22. The method of claim 21, further comprising the steps of providing any of:
a lookup table for translating between phonetic ID and stroke ID;
a lookup table for translating between stroke ID and phonetic ID; and
any of a lookup table for translating from phonetic ID to Chinese characters in said Chinese character set and a lookup table for translating from stroke ID to Chinese characters in said Chinese character set.

23. The method of claim 21, further comprising the step of:
providing a tone information table, wherein said phonetic sort is further sorted by tone of a character to support tone options in phrases.

24. The method of claim 21, further comprising the step of:
providing a frequency sorted word buffer for receiving candidate words and/or phrases from said word list.

25. The method of claim 21, wherein said lookup tables support one-to-many mappings in cases where a character can have either of multiple pronunciations and multiple stroke sequences.

26. The method of claim 21, further comprising the step of:
providing a phonetic database comprising key sequence information, spellings, and said phonetic ID.

27. The method of claim 21, said word list further comprising the step of:
providing a list of all possible spellings, sorted alphabetically;
wherein a spelling is compared with all possible spellings and, if matched, an index of said spelling is used to look up a phonetic ID range;
wherein said phonetic ID range table comprises a list of ending phonetic IDs for each spelling.

28. The method of claim 27, further comprising the step of:
providing a spelling table, wherein said spellings within said table are organized phonetic initials and finals.

29. An apparatus for Chinese phonetic text input, comprising:
a phonetic tree for translating from a key sequence to spellings;
a phonetic ID (PID) range lookup table;
phonetic ID word data; and
a lookup table for translating from a PID to Chinese characters.

30. An apparatus for Chinese phrasal stroke text input, comprising:
a single character stroke tree for stroke ID (SID) range lookup;
stoke ID word data; and
a lookup table for translating from an SID to Chinese characters.

31. An apparatus for Chinese phonetic text input, comprising:
an internal ID for a Chinese character set, said internal ID comprising a phonetic ID, a phonetic ID comprises either of an index of phonetic-sorted Chinese characters and an index of key-sorted, then phonetically sorted Chinese characters;
a word list for supporting phonetic text input; and
an ID range lookup structure for said Chinese character set, wherein an ID range lookup is provided for phonetic inputs.

32. The apparatus of claim 31, further comprising:
a lookup table for translating from phonetic ID to Chinese characters in said Chinese character set.

33. The apparatus of claim 31, further comprising:
a tone information table, wherein a phonetic sort is further sorted by tone of a character to support tone options in phrases.

34. The apparatus of claim 31, further comprising:
a frequency sorted word buffer for receiving candidate words and/or phrases from said word list.

35. The apparatus of claim 31, wherein said lookup tables support one-to-many mappings.

36. The apparatus of claim 31, further comprising:
a phonetic database comprising key sequence information, spellings, and said phonetic ID.

37. The apparatus of claim 31, said word list further comprising:
a list of all possible spellings, sorted alphabetically;
wherein a spelling is compared with all possible spellings and, if matched, an index of said spelling is used to look up a phonetic ID range;
wherein said phonetic ID range table comprises a list of ending phonetic IDs for each spelling.

38. The apparatus of claim 37, further comprising:
a spelling table, wherein said spellings within said table are organized by phonetic initials and finals.

39. A method for Chinese phonetic text input, comprising the steps of:
providing an internal ID for a Chinese character set, said internal ID comprising a phonetic ID, wherein said phonetic ID comprises either of an index of phonetically-sorted Chinese characters and an index of key-sorted, then phonetically sorted Chinese characters;
providing a word list for supporting phonetic text input; and
providing an ID range lookup structure for said Chinese character set, wherein an ID range lookup is provided for phonetic inputs.

40. The method of claim 39, further comprising the steps of providing:
a lookup table for translating from phonetic ID to Chinese characters in said Chinese character set.

41. The method of claim 39, further comprising the step of: providing a tone information table, wherein said phonetic sort is further sorted by tone of a character to support tone options in phrases.

42. The method of claim 39, further comprising the step of:
providing a frequency sorted word buffer for receiving candidate words and/or phrases from said word list.

43. The method of claim 39, wherein said lookup table supports one-to-many mappings in cases where a character can have multiple pronunciations.

44. The method of claim 39, further comprising the step of:
providing a phonetic database comprising key sequence information, spellings, and said phonetic ID.

45. The method of claim 39, said word list further comprising the step of:
providing a list of all possible spellings, sorted alphabetically;
wherein a spelling is compared with all possible spellings and, if matched, an index of said spelling is used to lookup a phonetic ID range;
wherein said phonetic ID range table comprises a list of ending phonetic IDs for each spelling.

46. The method of claim 45, further comprising the step of:
providing a spelling table, wherein said spellings within said table are organized by phonetic initials and finals.

47. The apparatus of claim 1, further comprising a module for receiving user stroke entry information that matches any stroke input.

48. The apparatus of claim 1, further comprising a module for receiving user
stoke
entry information from said stroke entry device, said module allowing users to enter a component of a character for the character.

49. The apparatus of claim 1, wherein the whole stroke sequence entered by a user and the plurality of groups of stroke sequences that are separated by zero or more of said delimiters split by said module splitting a whole stroke sequence entered by a user into a plurality of groups of stroke sequences that are separated by zero or more of said delimiters can be translated to a plurality of symbols that includes Chinese characters and punctuations numbers, letters and words of any languages and the combination thereof.

50. The apparatus of claim 1, further comprising a module for receiving user
stoke
entry information from said stroke entry device, said module allowing users to enter a character according to alternative stroke sequences.

51. The apparatus of claim 1, wherein said module for receiving user stoke entry information from said stroke entry device support a plurality of input system, said input system including five-stroke system and eight-stroke system.

52. The user interface of claim 6, wherein the data entry keypad for receiving user stroke entries, further comprising a key matching any stroke input.

53. The apparatus of claim 29, further comprising a letter key mapping that supports a plurality of key mappings including non-standard pinyin and BPMF key mapping.

54. The method of claim 15, further comprising entering a character according to alternative stroke sequences.

55. The method of claim 15, further comprising entering a component of a character for the character.

56. The method of claim 15, further comprising translating the whole stroke sequence entered by a user and the plurality of groups of stroke sequences that are separated by zero or more of said delimiters split by said module splitting a whole stroke sequence entered by a user into a plurality of groups of stroke sequences that are separated by zero or more of said delimiters into a plurality of symbols that include Chinese characters and punctuations numbers, letters and words of any languages and the combination thereof.

57. The apparatus of claim 7, wherein said at least two ID range lookup structures for the Chinese character set use fixed length in each ID field containing a plurality of bits, wherein a bit is reserved for an indicator to indicate whether a lookup value in the at least two ID range lookup structures is a single value or multiple values and the rest of the plurality of bits of the filed indicate where multiple values can be found.
